(19) United States
(12) Patent Application Publication
(10) Pub. No.: US 2009/0023481 A1
(43) Pub. Date: Jan. 22, 2009

(54) Portable electronic device carrier with charging system

(76) Inventors: David A. Foster, Orange City, FL (US); Arturo E. Bendek, JR., Miami, FL (US)

Correspondence Address: WEIDE & MILLER, LTD., 7251 W. LAKE MEAD BLVD., SUITE 530, LAS VEGAS, NV, 89128, US

(21) Appl. No.: 12/006,802

(22) Filed: Jan. 4, 2008

Related U.S. Application Data
(63) Continuation-in-part of application No. 11/880,184, filed on Jul. 19, 2007.

(51) Int. Cl. H04B 1/38; H02J 7/00; H04M 1/00

(52) U.S. Cl. 455/573; 320/103

(57) ABSTRACT

A portable electronic device carrier includes a charging system. The carrier is configured to at least partially house a portable electronic device such as a cell phone, PDA or the like. The carrier may comprise a pouch or have other configurations. The charging system comprises at least one battery. The battery may be configured to be charged by an external source via at least one external port or connector, or a source associated with the carrier, such as at least one photovoltaic cell. The charging port may comprise contacts which are engaged by an interface of the portable electronic device. In accordance with the invention, a portable electronic device is charged using a portable charging system associated with a carrier for the device.

### PRIOR APPLICATION DATA

This application is a continuation-in-part of U.S. application Ser. No. 11/880,184, entitled Portable Electronic Device Carrier with Charging System filed Jul. 19, 2007.

### FIELD OF THE INVENTION

The present invention relates to electric chargers for portable electronic devices such as cell phones and PDAs.

### BACKGROUND OF THE INVENTION

Cell phones, PDAs and other portable electronic devices are extremely prevalent. People are increasingly relying upon these devices for a range of purposes. For example, while cell phones were originally most commonly used by business travelers, they are now more widely used. For example, teens may carry cell phones in order to communicate with their parents in the event of an emergency, to communicate with their friends at school, or at home without tying up a home phone land line. In some cases, people are using their cell phone in replacement of their land lines. Similarly, PDAs have grown in popularity, owing to the range of functions they now provide.

One problem with these devices is, being portable, they are powered by a battery that requires frequent charging. Often, a user may find that their cell phone is not fully charged, and they may lose power during use. Loss of battery power to a PDA or cell phone can even result in loss of stored information.

Generally, these devices are charged by connecting them to a power source via a charging cable. Most commonly, these devices are provided with a “home” charging cable which allows the device to be charged via a 110V AC power source, such as the type commonly found in the home at a wall outlet. The device may also be provided with a “car” charger which allows the device to be charged via a 12V DC power source, such as the type commonly found in an automobile.

However, the device owner may forget their charger. For example, a traveler may forget to bring their home or car charger with them and arrive at a remote destination with no way to charge their device. Similarly, even if one charges their cell phone or PDA at home during the evening, the battery power may be depleted the next day when the device is used at school, at work or at another remote location. The user may then not be able to charge the device until they return home that evening.

One solution to this problem is to obtain an additional or backup battery. This battery may be charged at the same time as the main device battery and be transported with the device. If the main battery loses its charge, the second battery may be placed in the device. This, however, is a cumbersome solution to the problem. The solution requires one to purchase an expensive battery and keep that battery, like the battery in the main device, charged up. If one travels for a few days, the charge in both batteries may quickly be depleted, leaving the user without use of their device once again.

### SUMMARY OF THE INVENTION

A portable electronic device carrier includes a charging system. The carrier is configured to at least partially house a portable electronic device such as a cell phone, music device, iPod, camera, PDA, video game system, audio/video device, GPS unit, a laptop or other computer, or the like. The carrier may comprise a pouch or have other configurations.

In one embodiment, the charging system comprises at least one battery, a connector configured to connect the at least one battery to an external power source, and at least one charging port configured to be engaged by a portable electronic device. The charging port is configured to provide power from the battery to the portable electronic device when the portable electronic device is engaged therewith. The charging system may be used with a variety of external power supplies and the same charging system may be used with one or more different external power supplies alone or simultaneously.

In one or more embodiments of the invention, the at least one battery is rechargeable and is configured to be charged via the one or more external power sources. In other embodiments, the charging system may simply comprise a non-rechargeable battery coupled to the charging port, the non-rechargeable battery to be used, discarded, and replaced once its power has been expended. The charging system may also include features such as one or more controllers and an indicator providing an indication that charging of the device is occurring.

In one embodiment, the charging port is configured to be engaged with the portable electronic device when the device is placed in the carrier. For example, the charging port may comprise contacts which extend along an interior of the carrier for engagement by the interface of the device when it is placed in the carrier. The charging port may alternatively be configured to charge the device inductively (i.e. without direct contact).

In accordance with the invention, a portable electronic device is charged using a portable charging system associated with a carrier for the device.

Further objects, features, and advantages of the present invention over the prior art will become apparent from the detailed description of the drawings which follows, when considered with the attached figures.

### DESCRIPTION OF THE DRAWINGS

FIG. 1 is an external perspective view of a portable electronic device carrier a charging system in accordance with one embodiment of the invention;

FIG. 2 is a perspective view of the portable electronic device carrier illustrated in FIG. 1 with a flap thereof in an open position, exposing an interior of the carrier;

FIG. 3 is a top view of another embodiment portable electronic device carrier;

FIG. 4 schematically illustrates a charging system configuration in accordance with an embodiment of the invention;

FIG. 4 schematically illustrates a charging system configuration in accordance with a solar powered embodiment of the invention; and

FIG. 5 schematically illustrates a charging system configuration in accordance with an externally powered embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a carrier for a portable electronic device, the carrier having a charging system. In one embodiment, the charging system comprises at least one battery. In another embodiment, the charging system comprises a solar or photovoltaic unit. In another embodiment, the charging system comprises at least one battery and a solar or photovoltaic unit.

As used herein, the term “portable electronic device” (or PED) may comprise any of a variety of devices now know or later developed which include their own limited power supply, such as a re-chargeable battery, which power supply must be re-charged from an external source. Such devices may comprise, but are not limited to cell phones, PDAs, portable music devices, iPods, GPS units, laptop and other computers, video game systems, video players, cameras and other devices.

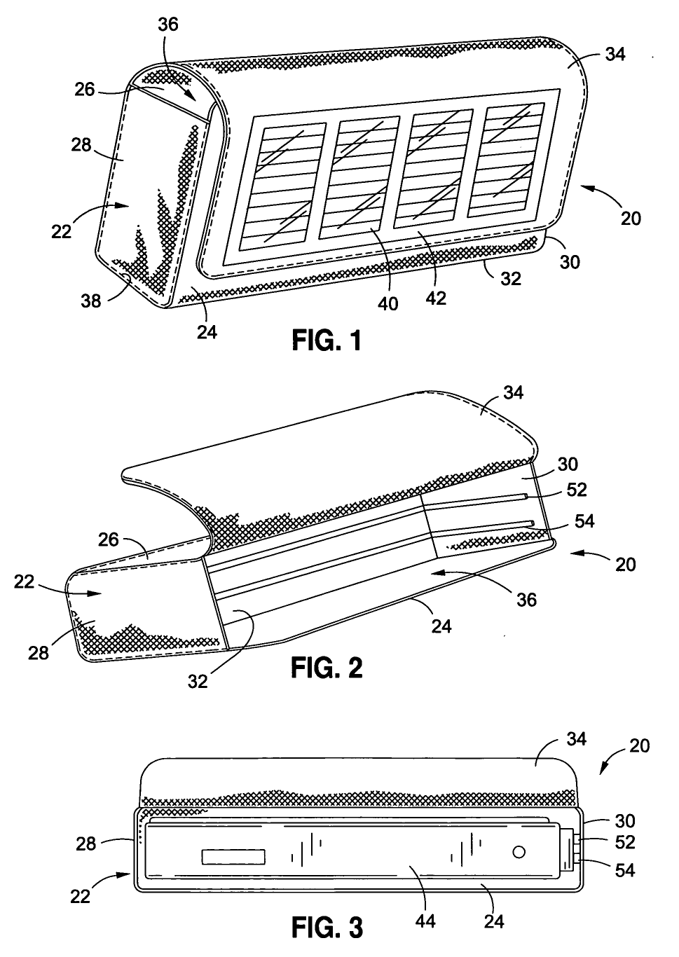

FIG. 1 illustrates a PED carrier 20 in accordance with one embodiment of the invention. The carrier 20 may have a variety of shapes, sizes and features, such as depending upon the one or more PEDs it is intended to be used with. In general, the carrier 20 is preferably configured house or contain at least a portion of a PED, such as for storage or transport.

FIGS. 1-3 illustrates a carrier 20 particularly suited for use in housing a cell phone. In this configuration, the carrier 20 has the form of a pouch configured to contain a cell phone. As illustrated, the carrier 20 has a body 22 having a front 24, a rear 26, a first end 28, a second end 30, a bottom 32, and a flap 34 which serves as a top. The front 24, rear 26, first end 28, second end 30 and bottom 32 preferably define a generally rectangular enclosure having an interior area 36. Each of the front 24, rear 26 first end 28 and second end 30 have a bottom portion which is connected to the bottom 32. A top end of the front 24, first end 28, and second end 30 extend to an otherwise open top. This open top may be selectively covered by the flap 34. As illustrated, the flap 34 is integral with the rear 26 of the carrier 20.

As illustrated in FIG. 1, the flap 34 may be folded upwardly and/or backwardly to open the body 22, providing access to the interior area 36. Alternatively, the flap 34 may be folded over forwardly and/or downwardly to the position illustrated in FIG. 1. At that time, the flap 34 generally closes the top of the interior area 36, the flap 34 extending over a front portion of the front 24 of the body 22.

In one embodiment, the body 22 may be constructed from a fabric material or a reinforced fabric material. The body 22 may be constructed of a wide range of materials, however. In one embodiment, various portions of the body 22 may be constructed as discrete panels, which panels are connected by stitching 38.

In one embodiment of the invention, the carrier 20 includes a charging system. The charging system is configured to provide power to a PED, preferably for charging a power supply, such as a rechargeable battery, thereof. As indicated below, the charging system may comprise an electrical circuit and various components.

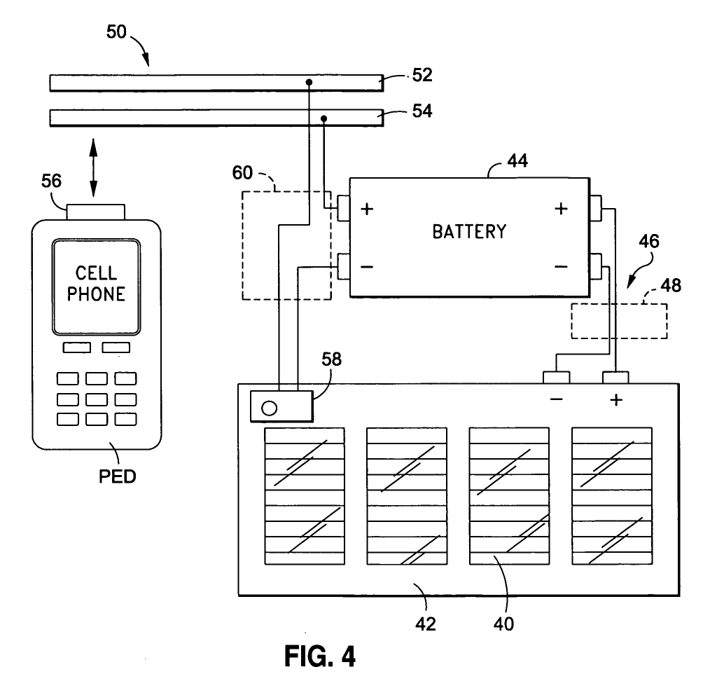

Referring to FIG. 4, the charging system includes a power source. This power source is preferably configured for use in charging a power source of a PED. In one embodiment, the power source is portable, meaning that it is configured to generate or provide power without connection to an external power source. In a preferred embodiment, the power source comprises one or more photovoltaic or solar cells 40. Such cells 40 may have a variety of configurations now known or later developed. Preferably, however, such cells 40 are configured convert light, such as solar energy, into electricity. In one embodiment, the carrier 20 may include a module or unit of two or more cells 40. For example, the carrier 20 is illustrated as including a panel 42 which includes four cells 40.

Preferably, the power source is associated with the carrier 20 so as to be transported therewith. In the embodiment where the power source comprises one or more photovoltaic cells 40, the cells 40 are preferably associated with an exterior portion of the carrier 20, whereby the cells 40 will be exposed to light. For example, in the embodiment illustrated in FIG. 1, the carrier 20 is configured to be mounted on a belt, and may thus include a mount (not shown) at the rear thereof. In that embodiment, the front of the flap 34 generally faces outwardly from the wearer of the carrier, towards light. Thus, in one embodiment, the cells 40 are located on a front portion of the flap 34. Of course, the cell(s) 40 may be located at other portions of the carrier 20 to accomplish the desired purpose. In one embodiment, cells 40 may be located at more than one portion of the carrier 20 (such as both the front and rear, the top and sides or the like). In this manner, the cells may be exposed to light from a variety of positions or directions.

The one or more cells 40 are preferably mounted to the carrier 20. The cell(s) 40 may be removably connected (such as with hook and loop fastener) or be permanently connected (such as with adhesive, by sewing, by trapping edge portions of the panel between layers of the body 22 of the carrier 20 or the like).

In one embodiment, the charging system includes a battery 44. The one or more solar or photovoltaic cells 40 (as illustrated, four cells 40 common to the panel 42) are configured to generate electricity or power when exposed to light. In a preferred embodiment, this power is used to charge the battery 44. Power may be supplied to the battery 44 by appropriate conductors 46, such as wire leads.

In a preferred embodiment, the battery 44 is associated with the carrier 20, such as by being mounted thereto. For example, the battery 44 may be mounted to or be mounted within the body 22 of the carrier 20. Preferably, the battery 44 is relatively small and lightweight and is configured to be rechargeable.

In one embodiment, a controller 48 may be utilized to control the flow of electricity to the battery 44, thus controlling the charging thereof. This controller 48 may be configured, for example, to ensure that the battery 44 is not overcharged or the like.

In one embodiment, the charging system includes a charging port 50. The charging port 50 preferably comprises an interface or link between a power source and a PED. As illustrated, the charging port 50 is coupled to the battery 44 (which as indicated above is, in turn, coupled to the cells 40).

The charging port 50 may have a variety of configurations. In one preferred embodiment, the charging port 50 comprises a first contact 52 and a second contact 54 having at least a portion configured as an electrical conductor. Referring to FIG. 2, in one embodiment the first and second conductors 52,54 comprise elongate leads or wires.

The charging port 50 may be connected to the power source in various manners. In the embodiment illustrated, a first conductor, such as a wire, leads from one of the terminals of the battery 44 to the first contact 52, and a second conductor, such as a wire, leads from the other of the terminals of the battery to the second contact 54.

The charging port 50 is configured to be engaged by a PED so that power is supplied from the power supply to the PED. In one embodiment, the PED includes an interface 56 for this purpose. The charging port 50 may be plugged into an appropriate interface 56 of the PED or vice versa. The interface 56 is preferably configured to engage the first and second contacts 52,54.

In one embodiment, as illustrated in FIG. 2, the charging port 50 may be configured to be engaged by the PED automatically when the PED is located in the carrier 20. For example, in one embodiment, the first and second contacts 52,54 may be configured to extend along one or more portions of the inside of the carrier 20, such as the bottom 32 and first and second sides 28,30. When a PED such as that illustrated in FIG. 4 having an interface 56 located at a first end thereof is located in the carrier 20, the interface 56 will engage the first and second contacts 52,54 automatically.

In other embodiments, the user may be required to connect the PED to the charging port 50. For example, the charging port 50 might comprise a connector located at the end of a pair of leads extending from the battery 44. The user may be required to plug the connector into a port of the PED. The charging port 50 may have other configurations for mating with one or more other types or configurations of PED interfaces. In one embodiment, the PED need not physically contact the charging port 50. For example, the charging port 50 may be configured to generate an energy field. The PED may be configured to generate electricity from the field. For example, the PED may include an interface having a coil which, when located in the field, generates electricity which may be utilized to charge the battery of the PED.

In one embodiment, the charging system may be configured to provide an indication to a user that the PED is being charged. In one embodiment, a visible indicator may be provided. As illustrated, in FIG. 4, the visible indicator may comprise an LED 58. In one embodiment, the LED 58 is placed in the circuit with the charging port 50 and power source, such as the battery 44, whereby when the charging circuit is complete, currently flows through the LED 58, thus causing it to illuminate. When the circuit is incomplete, such as when the PED is disconnected from the charging port 50, the LED 58 ceases to illuminate because no current flows thereto.

Of course, the indicator may have other configurations. For example, the indicator may be other types of visible indicators, such as other types of lights. The indicator might even comprise a display. The indicator could alternately, or in addition, comprise an audible indicator such as a speaker configured to output audible sound, such as a tone. The indicator could also be activated in other manners.

In one embodiment, the charging system may include a controller 60 for controlling the charging process, such as by controlling the flow of electricity to the PED. The controller 60 may also provide other control functions, such as controlling the LED 58 or other visual indicator.

FIG. 3 illustrates an embodiment of the invention where certain of the components of the charging system are illustrated as located within the carrier 20. As illustrated, the battery 44 may be located in the bottom of the carrier 20, with the first and second contacts 52,54 of the charging port 50 extending upwardly along one of the sides of the carrier. Of course, the components of the charging circuit could be associated with the carrier 20 in other manners.

In one embodiment, the PED interface (and/or the charging port) may be configured to ensure that the PED can be mated with the charging port only in the correct manner. For example, the PED interface may be non-symmetrical to ensure that it can only be engaged with the charging port in one orientation (thus preventing, for example, mating in an incorrect position and potential shorting out of the battery 44 or the PED).

The charging system may have a variety of other configurations, including other components. In one embodiment, for example, the system need not include a battery, or might include more than one battery for storing power for later use in charging a PED.

In use, the cells 40 are exposed to light. This might occur when the carrier 20 is located in an office, located on the dash of a car, worn on a belt outdoors, or a variety of other instances. Upon exposure to the light, the cells 40 generate electricity which is used to charge the battery 44. The battery 44 preferably provides a DC power supply for use in charging another device, such as a PED.

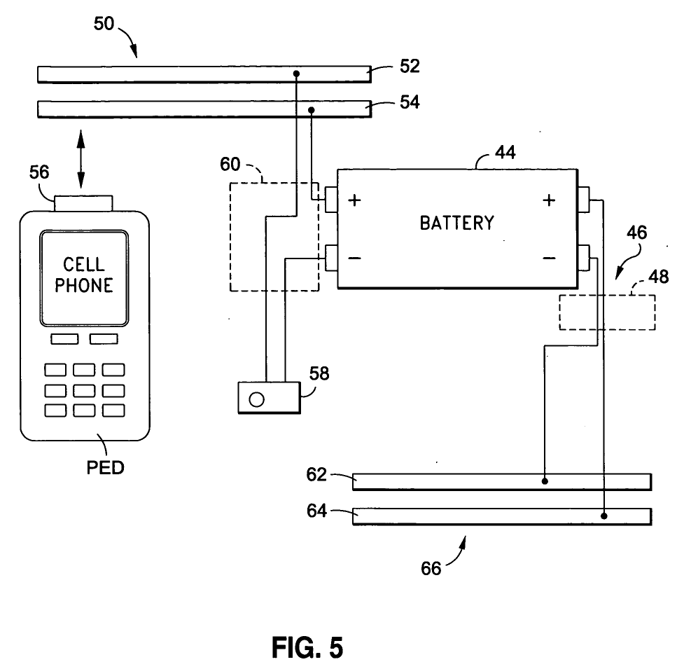

In accordance with another embodiment of the invention, the charging system need not include a solar or photovoltaic cell, but rather a battery may be configured to be charged with one or more other external sources of power. FIG. 5 illustrates such an embodiment, wherein the external source or sources of power are used to charge at least one battery 44 through appropriate conductors 46, such as wire leads.

As with above, in one or more embodiments, the battery 44 is associated with the carrier 20, such as by being mounted thereto. For example, the battery 44 may be mounted on or in the body 22 of the carrier. Many types of batteries may be used with the charging system, however it is preferred that the battery 44 be rechargeable, small, and lightweight. In other embodiments, the charging system may utilize non-rechargeable batteries such as alkaline. In these embodiments the battery 44 is not recharged but replaced with a new battery once its power has been expended.

Similar to FIG. 4, FIG. 5 also illustrates a charging port 50 which, in one or more embodiments, forms an interface linking a power source, such as the battery 44, and a PED. The charging port 50 may have various configurations. In one embodiment, the charging port comprises a first contact 52 and a second contact 54 having at least a portion thereof configured as an electrical conductor. The charging port 50 may comprise elongated leads or wires, or may be configured to be engaged by a PED such as by engaging the interface 56 of a PED. Various PEDs have various interfaces 56 and thus it is contemplated that the charging port 50 can come in a similar variety of configurations and be easily disconnected and reconnected from a PED's interface 56. In addition, the PED interface 56 and/or the charging port 50 may be configured to ensure that the PED can only be mated with the charging port in the correct manner. Thus, the PED interface 56 may be non-symmetrical, for example, to ensure that it can only be engaged in the correct orientation. This is advantageous in that it prevents the battery 44 from being shorted out and prevents damage to the PED from engaging the charging port 50 incorrectly.

As shown in FIG. 2, the charging port 50 may be configured to be engaged by the PED automatically when the PED is placed in the carrier 20. The first contact 52 and the second contact 54 may be arranged to extend along one or more portions of the carrier 22, such as its bottom 32 and/or its first side 28 or second side 30. Thus, when a PED, such as illustrated in FIG. 5, is placed in a carrier 20 the PED's interface 56 will engage the first and second contacts 52,54 automatically.

In other embodiments, physical contact with the PED may not be necessary to charge the PED. For example, the charging port 50 in one or more embodiments, may be configured to generate an energy field. The PED may include an interface 56 with a coil which generates electricity when the PED is within the field. This electricity may then be used to charge the PED's battery.

The charging port 50 may be connected to the power source in various ways. In the embodiment of FIG. 5, a first conductor connects one of the terminals of the battery 44 to the first contact 52, and a second conductor connects the other terminal of the battery 44 to the second contact 54. The conductors in one or more embodiments may be conductive leads such as wires or other conductive material.

Similarly, the battery 44 may be connected to an external power source in various ways. In one or more embodiments, the charging system includes an external port 66. The external port 66 of one embodiment comprises at least one connector, such as a first lead 62 and a second lead 64, but other embodiments may utilize different configurations. For example and as described below, the external port 66 may be configured to interface or link to a specific connector of a specific external power source such as a plug for a standard wall outlet. In addition, the external port 66 may be a coil or similar apparatus which generates power in the presence of an energy field produced by an external power source.

In some embodiments, the external port 66 may be stored in the carrier 20 when not in use and removed from the carrier when in use. For example, the external port 66 may have an electrical cord or cords as its conductors which allow the external port to be taken out of the carrier 20 and plugged in to an external power source such as a wall outlet. Each electrical cord is insulated such that it may be used outside the carrier and manipulated safely by users. In this example, the carrier's flap 34 may be opened so that the external port 66 may be taken out and plugged in to a wall outlet. Alternatively, in some embodiments, the external port 66 may extend through and retract back into an opening in the carrier 20 configured for the external port.

In other embodiments, the external port 66 may be on the exterior of the carrier 20. For example, the external port 66 may be mounted on the exterior of the carrier 20 and attach to one or more external power sources when in use. In one embodiment, the external port 66 may comprise a wall outlet plug which flips out to plug into to a wall outlet. In another embodiment, the external port 66 may be attached to one or more electrical cords extending from the interior to the exterior of the carrier 20. The charging system may then be recharged by placing it near an external power source and then connecting the external port 66 to the interface or leads of the power source.

A primary conductor connects one recharge terminal of the battery 44 to a first lead 62, and a secondary conductor connects another recharge terminal of the battery 44 to a second lead 64. It is contemplated that additional recharge leads, such as a ground, may be present in one or more embodiments of the invention. Further, in some embodiments, a controller 48 may be used to control the charging and/or recharging of the battery 44. In this manner, the controller 48 may be used to ensure that the battery 44 is properly charged and not damaged such as by overcharging or the like.

Generally, an external power source will be connected to the charging system by connecting the leads or terminals of the external power source to the first and second leads 62,64 or other connector of the charging system. Power from the external power source can then recharge the battery 44 through the conductors described above. The first and second leads 62,64 may be configured to accept or connect to various power sources. For example, the first and second leads 62,64 may be configured as a standard wall plug to be plugged in to a standard AC wall outlet or automobile 12V outlet. The first and second leads 62,64 may also be configured with traditional, known, proprietary, or future developed interfaces so that power can be obtained from external or other power sources.

It is contemplated that the external power source may be any power. It is also contemplated that one or more external power sources may be used simultaneously or alone with the charging system. The external power sources may be any power source now known or later developed including but not limited to photovoltaic or solar panels, external batteries, wall outlets, or human or motion generated electricity.

Finally, it is also contemplated that in one or more embodiments the battery 44 may be removable from the charging system and independently recharged and reconnected to the charging system. In addition and as stated above, the battery 44 in some embodiments may not be rechargeable and thus would be used, discarded, and replaced with a new battery 44 as necessary. In such a configuration, the charging system need not include an external port or connector.

In some embodiments, an indication to the user that the PED is being charged may be provided. In one embodiment, a visible indicator such as a LED 58 may be provided. The LED 58 may be placed in the circuit such that when the charging circuit is complete, current flows through the LED 58 causing it to illuminate. When current ceases to flow through the LED 59 it correspondingly ceases to illuminate. Other types of indicators may be used as well such as but not limited to a display, blinking lights, speakers, sounds, and/or tones. These an other indicators may be activated in response to charging as described or in response to one or more other events such as when the charge is complete or when the battery 44 is low.

As described with reference to FIG. 4, the controller 60 controls the charging process such as by controlling the flow of electricity to a PED. The controller 60 may also provide other control functions such as controlling the LED 58 or other indicators.

As with the embodiment of FIG. 3, the components of the embodiment in FIG. 5 may be located within a carrier 20. Of course, the components of the charging system may be associated with the carrier 20 in other ways. In addition, the charging system may have a variety of other configurations, including other components.

A user may charge the battery or batteries of their PED by simply associating the PED with the carrier 20. The PED is associated with the charging port 50. As indicated, in a preferred embodiment, this may comprise engaging an interface 56 of the PED with contacts 52,54 of the charging port 50 when the PED is located in the carrier 20.

Once connected to the charging port 50, electricity is provided to the PED from the battery 44. In embodiments where there is not battery, electricity may be provided to the PED from one or more external power sources providing electricity to the external port 66. Preferably, charging status is indicated to the user, such as via the LED 58.

In accordance with the invention, a charging source is conveniently provided for a PED. The charging source does not require a standard external fixed power source such as a home or office AC outlet or a car DC outlet. Further, the power source is conveniently associated with a carrier for the PED. PEDs are commonly transported in their carriers. In accordance with the invention, when the PED is being transported or stored, it is also charged.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A charger for a portable electronic device comprising:
a carrier, said carrier comprising a body defining an interior area for housing at least a portion of said portable electronic device; and
a charging system, said charging system comprising:
at least one external port configured to receive electricity from at least one external power source;
at least one battery configured to be charged by said electricity received by said at least one external port; and
at least one charging port configured to be engaged by a portable electronic device, said charging port coupled to said at least one battery to provide electricity to said portable electronic device when said portable electronic device is engaged therewith.

2. The charger in accordance with claim 1 wherein said portable electronic device is selected from the group consisting of a cell phone, a PDA, a music player and a computer.

3. The charger in accordance with claim 1 wherein said at least one external port is located at an exterior of said carrier.

4. The charger in accordance with claim 1 wherein said carrier comprises a pouch having a front and back, a bottom, two opposing ends, and a flap configured to be selectively moved over an otherwise open top of said pouch.

5. The charger in accordance with claim 4 wherein said at least one external port is located in said pouch, said external port being removable from said pouch to receive power from said at least one external power source.

6. The charger in accordance with claim 1 wherein said charging port comprises a pair of contacts, said contacts separated from one another and connected to said carrier.

7. The charger in accordance with claim 1 wherein said charging system includes an indicator configured to indicate when electricity is being provided to said portable electronic device.

8. The charger in accordance with claim 7 wherein said indicator comprises a light.

9. A cell phone charging system comprising:
a cell phone carrier comprising a pouch defining an interior area for housing at least a portion of a cell phone; and
a charging system, said charging system comprising:
at least one external port configured to receive power from at least one external power source;
at least one battery configured to store power received by said at least one external port; and
a charging port configured to deliver power from said battery to said cell phone;
said charging system associated with said pouch.

10. The cell phone charging system in accordance with claim 9 wherein said charging port comprises a least one contact for connection with a charging interface of said cell phone.

11. The cell phone charging system in accordance with claim 10 wherein said at least one contact is located in said interior area for engagement with said charging interface when said cell phone is located in said pouch.

12. The cell phone charging system in accordance with claim 9 wherein said at least one external port is located at an exterior of said pouch.

13. The cell phone charging system in accordance with claim 9 wherein said charging system includes an indicator configured to indicate when power is being supplied to said cell phone.

14. The cell phone charging system in accordance with claim 9 wherein said charging system includes at least one controller.

15. The cell phone charging system in accordance with claim 9 wherein said at least one external port is connected to said battery by at least one electrical cord.

16. The cell phone charging system in accordance with claim 15 wherein said at least one external port is in said pouch, said external port being removable to receive power from said at least one external power source.
